(19) United States
(12) Patent Application Publication
(10) Pub. No.: US 2006/0097429 A1
(43) Pub. Date: May 11, 2006

(54) Fibrillar apparatus and methods for making it

(76) Inventor: James Edmond Van Trump, Ashland, OR (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/218,219

(22) Filed: Sep. 1, 2005

Related U.S. Application Data
(60) Provisional application No. 60/607,325, filed on Sep. 3, 2004.

(51) Int. Cl. B29B 17/00; D04H 13/00

(52) U.S. Cl. 264/344; 442/361; 442/363

(57) ABSTRACT

This invention relates to a fibrillar apparatus, such as a fibrillar microstructure, that has fibrils protruding from the surface of a substrate, and methods for making it.

This application claims the benefit of U.S. Provisional Application No. 60/607,325, filed on Sep. 3, 2004, which is incorporated in its entirety as a part hereof for all purposes.

### FIELD OF THE INVENTION

This invention relates to a fibrillar apparatus, such as a fibrillar microstructure, that has fibrils protruding from the surface of a substrate, and methods for making it.

### BACKGROUND OF THE INVENTION

U.S. Pat. No. 6,767,853 discloses a fibrous substrate for artificial leather that is made by impregnating a nonwoven fabric prepared from polymeric islands-in-the-sea fibers with a solution of an elastic polymer such as polyurethane, and solidifying the elastic polymer. The polymeric fibers are referred to as microfine fiber-forming fibers, and are transformed by the manufacturing process into microfine fibers, which transformation generates bundles of microfine fibers from the microfine fiber-forming fibers.

The microfine fiber-forming fibers are first opened with a card, passed through a webber to form random webs or cross-lap webs. The resultant webs are laminated to desired weight and thickness. The laminated webs are then subjected to a known entangling treatment such as needle punching or water-jet entanglement to convert the webs to a nonwoven fabric. After this fabric has been impregnated with an elastic polymer, the resultant product is subjected to wet coagulation, or is heat-treated or treated with hot water to effect dry coagulation or hot water coagulation. Next, the fibrous substrate is treated with a liquid that is a non-solvent for the polymer from which the islands are made and is a non-solvent for the polymer used for impregnation, but that is a solvent or a decomposing agent for the polymer from which the sea component of the microfine fiber-forming fibers is prepared. By this treatment, the sea component polymer is removed from the microfine fiber-forming fibers so that the fibers are converted to bundles of microfine fibers, and the elastic polymer with which the fabric is impregnated is solidified into a sponge or block form to make a structure wherein the solidified elastic polymer covers and encircles the microfine fiber bundles. The sheet goods prepared by this method can be given a suede texture by napping the surface from which the microfine fibers protrude.

Although other references such as U.S. Pat. No. 4,118,529, U.S. Pat. No. 3,932,687 and GB 1,300,268 disclose similar methods for making a piled, plush or raised fabric such as a velveteen, flannel or corduroy, a need remains in the art for a method that is more efficient, and that can make a bigger variety of products, than those currently known.

### SUMMARY OF THE INVENTION

One embodiment of this invention is a method for making a fibrillar microstructure by

(a) providing a plurality of composite filaments, each filament comprising a plurality of elongated domains of at least a first polymer; wherein each elongated domain is elongated along a longitudinal axis of the filament, and is dispersed within a matrix of a second polymer; and wherein a longitudinal axis of each dispersed domain is not orthogonal to the longitudinal axis of the filament;

(b) forming a fabric from the filaments and a backing;

(c) removing the matrix polymer from the fabric with a liquid solvent;

(d) removing the solvent from the fabric by displacing it with a drying liquid that is below its critical point; and

(e) removing the drying liquid from the fabric by converting it to a gas above its critical point.

Another embodiment of this invention is a method for making a fibrillar microstructure by

(a) providing a plurality of composite filaments, each filament comprising a plurality of elongated domains of at least a first polymer; wherein each elongated domain is elongated along a longitudinal axis of the filament, and is dispersed within a matrix of a second polymer; and wherein a longitudinal axis of each dispersed domain is not orthogonal to the longitudinal axis of the filament;

(b) forming a fabric from the filaments and a backing;

(c) removing the matrix polymer from the fabric with a liquid solvent;

(d) removing the solvent from the fabric by lyophilization.

### BRIEF DESCRIPTION OF THE DRAWINGS

FIG. 1 is a schematic representation of various steps that are taken in a process of this invention.

FIG. 2 is an illustration of devices used in a process of this invention.

FIG. 3 is a schematic representation of various steps that are taken in a process of this invention.

FIG. 4 is a photomicrograph of the fibrillar microstructure produced by the process described in Example 1.

FIG. 5 is a photomicrograph of the fibrillar microstructure produced by the process described in Example 2.

FIG. 6 is a photomicrograph of the fibrillar microstructure produced by the process described in Example 3.

FIG. 7 is a side elevation view of a fibrillar microstructure having a first tier of fibrils secured to a substrate, and a second tier of fibrils that is each secured to a single first tier fibril.

FIG. 8 is a side elevation view of a composite filament having dispersed domains that are not continuous along the length of the filament made according to a process of this invention.

FIG. 9 is a side elevation view of a composite filament having dispersed domains that are continuous along the length of the filament made according to a process of this invention.

FIG. 10 is a cut-away view of the side elevation of a composite filament having dispersed domains that are continuous along the length of the filament made according to a process of this invention.

FIGS. 11 to 22 are cross-sectional views of various composite filaments made according to a process of this invention.

FIG. 23 is a side elevation view of a spinning device used to make an islands-in-the-sea composite filament.

FIG. 24 is a photomicrograph of the fibrillar microstructure produced by the process described in Example 4.

### DESCRIPTION OF THE PREFERRED EMBODIMENTS OF THE INVENTION

One embodiment of the fibrillar apparatus of this invention provides a fibrillar microstructure that is referred to as fibrillar because it is constituted of fibrils, which may be considered to be similar to extremely fine filaments, and a substrate, such as a backing material. In a fibrillar microstructure, each of the fibrils is an individual nano to micro-dimensioned protrusion that is secured to the substrate and extends, or is projected, therefrom. The substrate is generally planar in its dimensions, but is often prepared from material that gives it flexibility and thus the capability of being formed into a variety of shapes. In one method of this invention, such a fibrillar microstructure is made from an aggregation of composite filaments.

A composite filament usually, but not always, has the shape of an elongated cylinder with a circular or essentially circular cross-sectional shape. The composite filament is made from more than one polymer, and contains a plurality of elongated domains of at least a first polymer that are elongated along a longitudinal axis of the filament. The elongated domains of the first polymer are dispersed (as a phase that is discontinuous throughout the body of the filament) within a matrix (i.e. a continuous phase) of a second polymer. The matrix of the second polymer also has an elongated shape. The matrix of the second polymer, together with the dispersed domains contained therein, is, for the purpose of forming the filament, elongated along the longitudinal axis of the filament. The longitudinal axis of each dispersed domain is not orthogonal to the longitudinal axis of the filament. Preferably, the longitudinal axis of each dispersed domain is essentially parallel, if not parallel, to the longitudinal axis of both the matrix domain and the filament. The longitudinal axis of each dispersed domain is essentially parallel to the longitudinal axis of the matrix domain and/or the filament when the two axes in question have an angle of intersection of less than 20°. The longitudinal axis of the matrix domain may be considered to be coincident with, if not the same as, the longitudinal axis of the filament.

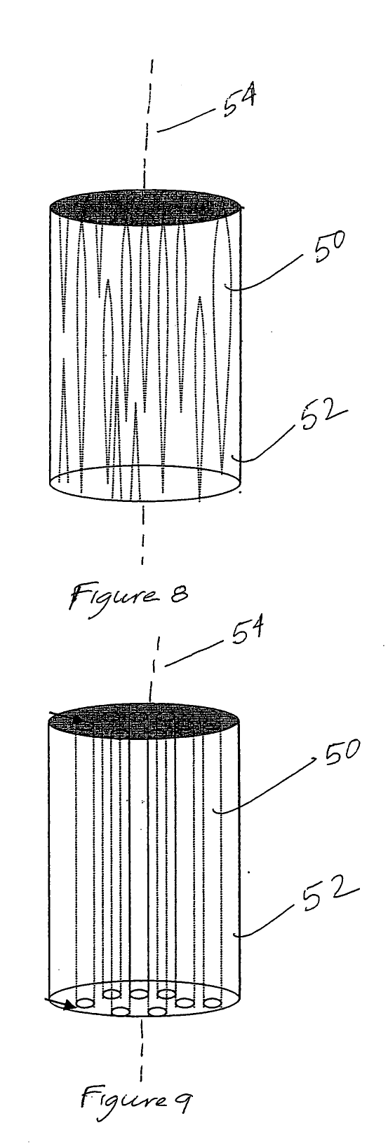

Various views of such a composite filament may be seen in FIGS. 8˜22. In each of those figures, an elongated domain 50 of at least a first polymer is dispersed in a matrix 52 of a second polymer. In the perspective views of FIGS. 8˜10, the manner in which the dispersed domains and the matrix are elongated along the longitudinal axis of the filament 54 is displayed. FIG. 8 shows a filament in which the dispersed domains are not continuous along the longitudinal length of the filament. FIGS. 9 and 10 show dispersed domains that, although they are not continuous across all dimensions of the body of the filament and are thus accurately characterized as “dispersed”, are nevertheless continuous along the length of the filament.

In FIGS. 11˜22, a cross-sectional view of a typical filament is shown. These figures show various examples of different shapes in which the dispersed domains 50 may be formed as they reside within the matrix 52 of the filament 54. Although a more uniform distribution of the fibrils in the fibrillar microstructure made by the processes of this invention may be obtained if the dispersed domains are formed in essentially the shape of an elongated cylinder, other shapes may be used if desired. If a dispersed domain is formed in essentially the shape of an elongated cylinder, its cross-sectional shape will be essentially that of a circle. A dispersed domain may, however, be formed such that its cross-sectional shape can be selected from shapes such as elliptical, oval, wedge or polygonal such as triangular, diamond, rectangular, hexagonal or octagonal.

In FIGS. 11˜14, the use of cross-hatching indicates that each of the dispersed domains is prepared from the same polymer. FIGS. 15˜22 show an alternative embodiment of the filaments in which the dispersed domains are formed from different polymers, such as a first and a third polymer, as indicated by the use of cross-hatching and dots. Alternatively, however, a dispersed domain may be formed from a mixture of a first and third polymer in a polymer blend, and, if desired, each dispersed domain may be formed from the same such blend, or from different polymers or different blends of polymers. (References herein to “first and third polymers” should be understood to include a reference also to fourth, fifth and other polymers should it be desired to use same in a dispersed domain.)

The content of a composite filament by weight may be from about 5 to about 50 percent of the first polymer (or the first and third polymers combined), and from about 50 to about 95 percent of the second polymer; or, alternatively, from about 5 to about 30 percent of the first polymer (or the first and third polymers combined), and from about 70 to about 95 percent of the second polymer; or, in a further alternative, from about 10 to about 20 percent of the first polymer (or the first and third polymers combined), and from about 80 to about 90 percent of the second polymer.

As the first and second polymers (and third polymer when present) will be melt or solution processible over the same temperature range, a composite filament may, in one embodiment of the process of this invention, be formed by an islands-in-a-sea spinning process. A filament is obtained from such a process in which the islands of the filament are considered to be dispersed domains that are dispersed in the sea, and the sea is considered to be the matrix of the filament. In such a process, the filaments are spun through an apparatus such as shown in FIG. 23. In the apparatus of FIG. 23, three kinds of spinnerets 64, 65, and 66 are contained in a spinning apparatus 63 in combination. A partition is usable for independently supplying the sea constituent polymer B and the island constituent polymer A into the spinnerets 64 and 65, respectively. As previously noted, the island constituent polymer may be a mixture or blend of polymers, i.e. a polymeric composition, instead of just one polymer.

The spinnerets 64 and 65 are provided with a plurality of orifices 71 and 72, respectively. The lower ends of the orifices 71 are inserted into the upper ends of the orifices 72. The sea constituent, polymeric liquid B, is supplied into the orifices 72 through passages 69, which are spaces between the lower end portions of the orifices 71 and the upper end portions of the orifices 72.

The island constituent, polymeric liquid A, passes into the orifices 71 through passages 67 and 68 connected with the orifices 71 and then is supplied into the orifices 72. Through contacting of the constituent polymeric liquids A and B in the spinneret 65, both polymeric liquids A and B are incorporated into a composite stream in which the polymeric liquid B surrounds the separated individual strands of polymeric liquid A.

The spinneret 66 is provided with a plurality of orifices 73 and funnel shaped chambers 70. The upper ends of the chambers 70 are connected with the lower ends of the orifices 72, and the lower ends of the chambers 70 are connected to the orifices 73. Numerous composite streams containing polymeric liquids A and B are fed into the funnel-shaped chambers 70 through the orifices 72 and united into islands-in-the-sea composite streams followed by extruding into islands-in-the-sea composite filaments through the orifices 73. Other processes for making a composite filament having elongated domains dispersed within a matrix are disclosed in U.S. Pat. No. 4,118,529 and U.S. Pat. No. 4,496,619, each of which is incorporated as a part hereof for its disclosure concerning processes for making filaments and the filaments made thereby.

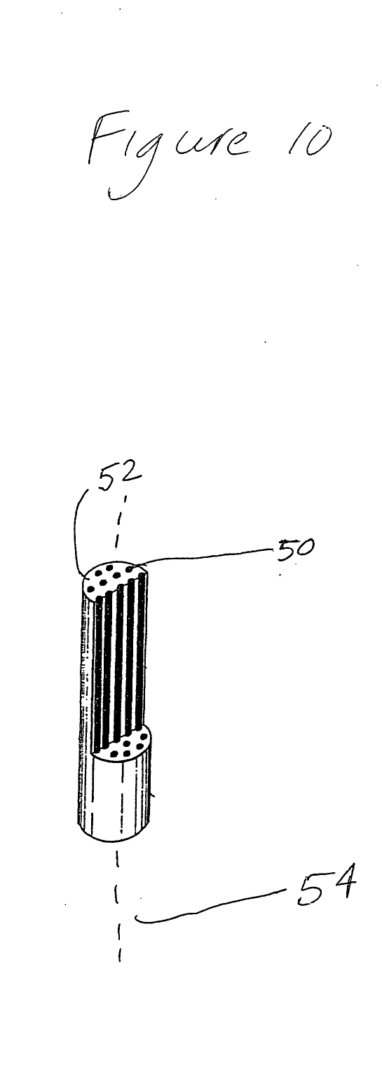

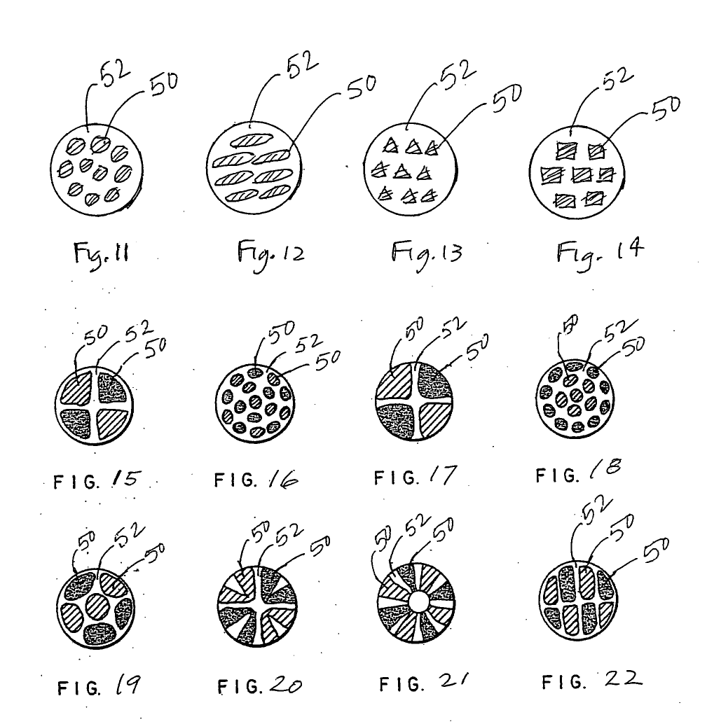

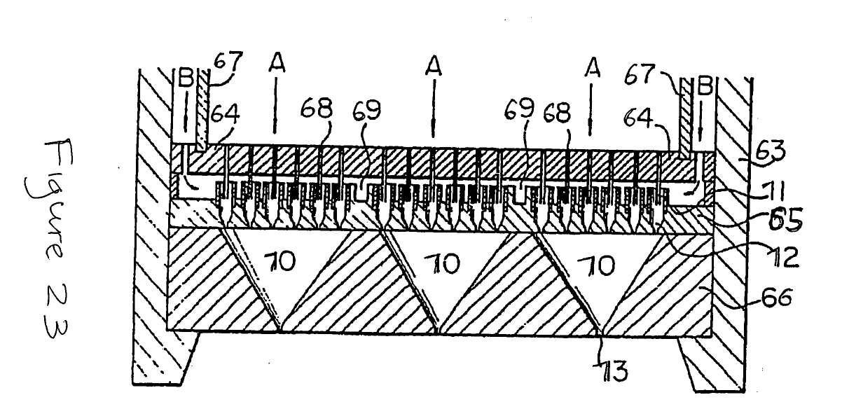

As noted above, although the island strands that are passed out through orifices 71 typically have a cylindrical shape and thus an essentially round cross-sectional shape, other cross-sectional shapes such as oval, rectangular, channeled or those shown in FIGS. 15, 17 and 19˜22, may be utilized as desired by cutting the orifice in a shape that will produce the corresponding shape in the strand of island polymeric liquid A. The shape and cross-sectional area of a fibril may, but need not be, constant along the length of the fibril. When the islands are formed as cylindrical-shaped strands, there can be as many as several hundred island domains dispersed within the matrix of a single filament.

Alternatively, a composite filament may be prepared by conventional sheath/core spinning technology, which would give a filament in which the core, as the dispersed domain, would be contained in effect as a single island within a sea or matrix comprised of the sheath.

In a further alternative, a composite filament may be prepared by the conventional melt blending of the first and second polymers where the content in the mixture of the first polymer, which will become the dispersed domain, is not more than about 20 weight percent. It is also preferred that the polymer during melt extrusion (at a spin temperature, for example, of 290° C.) should be such that the matrix domain polymer is more viscous than the dispersed (fibril producing) domain polymer.

In sheared, high viscosity systems, the dispersed domain dimension is dominated by the viscosity ratio between fluids and the shear rate. In sheared systems, if the dispersed (discontinuous) domain is more than about twice the viscosity of the matrix (continuous) domain, little breakup will occur. If, however, a mixing apparatus is used that provides both shear and elongational flow mixing, such as a twin screw extruder, good dispersion of the first polymer may be obtained. If the matrix domain polymer is more viscous than the dispersed domain polymer, it is possible to spin fibers of up to about 20 wt % dispersed domian polymer and obtain filaments containing dispersed domain fibrils with a reasonably tight diameter distribution at or below about 100 nm. Above about 20 wt % of the dispersed domain polymer, varying degrees of post-mixing reaggregation may be observed, and spinning continuity may be degraded. Nevertheless, using a dispersed domain polymer that is more viscous than the matrix domain polymer will reduce the likelihood that it will be possible to obtain good quality filaments.

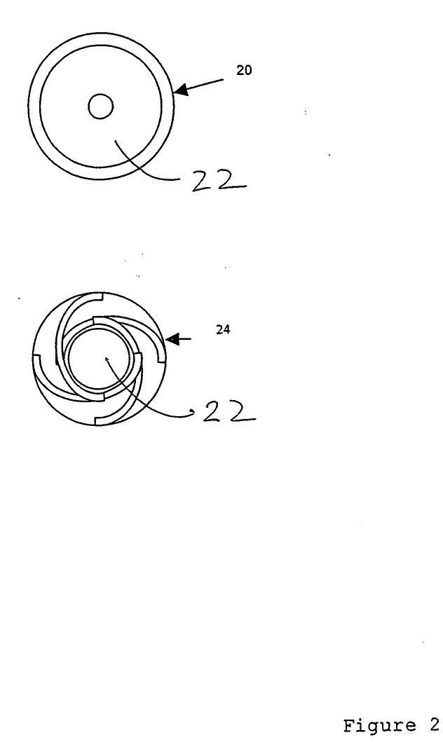

Forming a polymer blend in accordance with the content and viscosity relationships described above will give good dispersion of the first polymer as a dispersed domain within the matrix of the second polymer simply by physical mixing. A mixture of polymers prepared in that manner may then be extruded through a conventional tubular spinneret capillary, such as one or more of those shown in FIG. 2 of U.S. Pat. No. 6,619,947. Referring again to FIG. 8 hereof, a composite filament prepared by extrusion through a conventional tubular spinneret capillary often has dispersed domains that are not continuous along the longitudinal length of the filament. These dispersed domains may have an elliptical or irregular cross sectional shape.

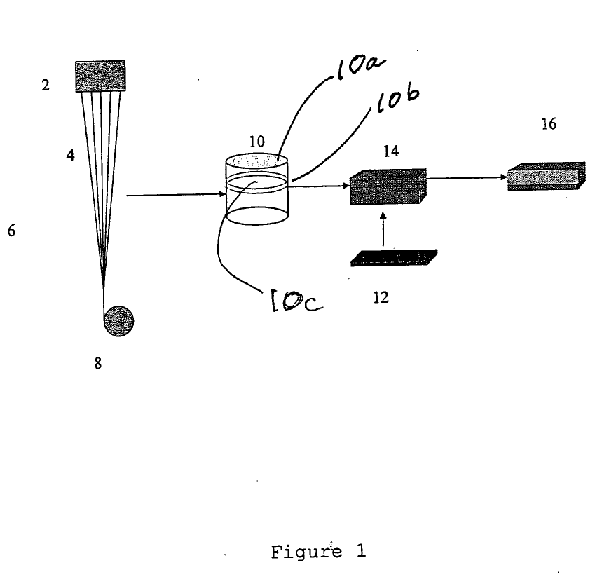

FIG. 1 illustrates various additional steps in a process of this invention that occur after the composite filaments have been prepared. Composite filaments, made as described herein or by any other appropriate process, exit a spinneret 2. A collective bundle of these filaments may, for ease of handling, be gathered together and forwarded as fibers 4. The fibers are formed in a high-speed, continuous or near continuous, spinning process 6, and the fibers are formed into a yarn that is then wound up on a roll 8. In alternative embodiments, the yarn may be twisted before any of the subsequent steps are taken.

The composite filaments, typically in the form of a yarn, are then consolidated into an object, such as a cylinder, bar or block, having at least one surface in which the longitudinal axis of each dispersed domain is essentially orthogonal to the plane of that surface of the object. The longitudinal axis of a dispersed domain is essentially orthogonal to a plane of the surface of the object when, if it is not actually orthogonal (i.e. intersecting the plane at an angle of 90°), the acute angle formed by the intersection of the axis and the plane is at least 70° and is preferably at least 80°. A portion of the object that includes the surface is then removed, the portion is secured to a substrate, and the matrix polymer is removed from that portion of the object.

Alternatively, after the composite filaments (or a yarn thereof) are consolidated into an object having at least one surface in which the longitudinal axis of each dispersed domain is essentially orthogonal to the plane of the surface of the object, a substrate may be secured to the surface of the object. A portion of the object that includes the surface that is secured to the substrate is then separated from the remainder of the object, and the matrix polymer is then removed from the portion of the object that is secured to the substrate.

The steps described above are also illustrated in FIG. 1 wherein a large bundle of fibers 4 undergo consolidation 6 into a yarn, and are then fused together to form a uni-axial object having a surface in which the longitudinal axis of each dispersed domain is essentially orthogonal to the plane of the surface. Consolidation to form the object can be performed by a process 8 in which the filaments (e.g. as yarn) are placed under pressure at a temperature at which they will soften, such as by pultrusion. The object shown in FIG. 1 as a work piece is a cylinder 10 having a top surface 10a in which the longitudinal axis of each dispersed domain is essentially orthogonal to the plane that is coincident with top surface 10a. A cut is made at location 10b in a manner that enables removal of a portion (e.g. a layer) of the cylindrical piece in the form of disc 10c. Disc 10c is then reshaped into the form of block 14. Reshaping is not necessarily required, however, in the case where it is desired to secure the portion of the object separated from the remainder of the object to a substrate that has the same shape as the portion of the object.

Block 14 is secured to substrate 12, and this may be accomplished by chemical adhesion (e.g. using an adhesive), melt adhesion or by a physical attachment. Substrate 12 may be flexible, as in the form of a film, foam or fabric, or may be a more rigid slab or plank. It may in some embodiments be desirable to use a substrate that is permeable to the passage of all fluids, or to only certain fluids (such as water), but not to the passage of undesirable microorganisms. If the block 14 is secured to substrate 12 by melt adhesion, the substrate will be prepared from a polymer that melts or at least flows at a lower temperature than either the dispersed or matrix polymers in block 14. After block 14, the reshaped layer removed from cylindrical work piece 10, is secured to substrate 12, a step is performed at 16 in which the matrix polymer is removed from the material from which the yarn and thus also the work piece 10 and the block 14 were fabricated.

After removal of the matrix polymer, each dispersed domain that had been contained within the matrix remains embedded or otherwise secured individually to the substrate, but, as it is no longer confined by the matrix, it now constitutes one of many free-standing fibrils that together with the substrate constitute a fibrillar microstructure. These fibrils are produced by removal of the matrix with equal effect whether they are obtained from dispersed domains that had originally been discontinuous, or from dispersed domains that had originally been continuous along the length of a filament such as a group of islands in the sea of a single filament, or a single island as the core of a sheath/core filament.

In an alternative embodiment not shown in FIG. 1, the substrate 12 would be secured to the top surface 10a of cylindrical piece 10 before cut 10b is made to remove disc 10c from piece 10. The step of removing the matrix polymer is then performed as mentioned above. This embodiment is employed when it is not desired to reshape the layer that is removed from the work piece (i.e. the portion that is removed from the object) before the layer/portion is secured to the substrate, or where securing the substrate first is advantageous for other reasons.

In a further alternative embodiment, the object 10 would be formed from filaments (or yarns thereof) that are cut to a length such that the filaments (or yarns) as consolidated form an object that is the correct shape and size to itself be secured in its entirety to the substrate. The filaments or yarns would thus be consolidated into an object having at least one surface in which the longitudinal axis of each dispersed domain is essentially orthogonal to the plane of that surface. The object itself is then secured to a substrate, and the substrate and object are typically secured to each other at the interface of the substrate with a surface of the object in which the longitudinal axis of each dispersed domain is essentially orthogonal to the plane of that surface. In this embodiment, no portion of the object is removed, and the entire object is secured to the substrate. Matrix removal is then performed as described above.

Referring again to the embodiment shown in FIG. 1, the disc 10c that is removed from cylindrical work piece 10 may, instead of being reshaped as block 14, be reshaped as a band or ribbon. As with disc 10c and block 14, however, the ribbon has a surface in which the longitudinal axis of each dispersed domain is essentially orthogonal to the plane of that surface. The ribbon may then be disposed around a wheel as shown in FIG. 2. The ribbon 20 may be disposed about the entire circumference of a wheel 22, or the sections 24 of the ribbon may be attached in a regularly repeating fashion to a wheel 22 such as by a spiral winding. In either event, the ribbon, when curved to fit a wheel, still has a surface in which the longitudinal axis of each dispersed domain is essentially orthogonal to the plane of the surface thereof because the curved surface may be considered to be composed of a series of infinitely small sections of the plane of orthogonality that characterized the ribbon when still flat before winding, each such infinitely small plane being intersected by the longitudinal axis of at least one dispersed domain.

The ribbon, or portion thereof, that has been wound around wheel may then be utilized to make a fibrillar microstructure by the process shown in FIG. 3. The removal of a layer from the ribbon/portion 30 is caused by the rotation of the wheel against a knife 32, which causes a layer to be skived off. This layer is then transferred continuously to a pliable backing 34, which is fed to the location of the knife cut as a substrate to pick up the layer. After the layer is secured to the film, such as by passing through hot rolls 36, a composite sheet 38 is formed. Removal of the matrix polymer as described above from the composite sheet yields a fibrillar microstructure. Alternatively, the backing may be secured to the ribbon/portion before a layer is skived off. This continuous process has advantages of speed and efficiency over a discontinuous process such as illustrated in FIG. 1 in which each block 14 is secured separately to a substrate 12.

In the processes described above, removal of the matrix polymer may be accomplished by contacting the consolidated object or portion thereof with a fluid that is a solvent for the matrix polymer but is not a solvent for any polymer or material from which the dispersed domains or the substrate have been made. Frequently, this fluid is an organic liquid such as acetone or toluene, but it may also be an aqueous solvent such as water, especially heated water, or an aqueous mixture such as aqueous caustic, especially heated aqueous caustic.

As mentioned above, the dispersed domain, such as the island portion of an island-in-the-sea filament, may be prepared from a mixture of first and third polymers, or, should it be desirable, a mixture of more than two polymers (such as fourth, fifth polymers etc.). When the dispersed domains are prepared from a polymer mixture, it is possible to prepare a fibrillar microstructure in which there are two tiers of fibrils. This may be accomplished by contacting the consolidated object or portion thereof with a first fluid that is a solvent for one of the polymers from which the dispersed domain has been made but is not a solvent for any polymer or material from which the remainder of the dispersed domain, the matrix or the substrate have been made. The matrix polymer is then removed as described above by contacting the consolidated object or portion thereof with a second fluid that is a solvent for the matrix polymer but is not a solvent for any polymer or material from which any portion of the dispersed domain or the substrate have been made.

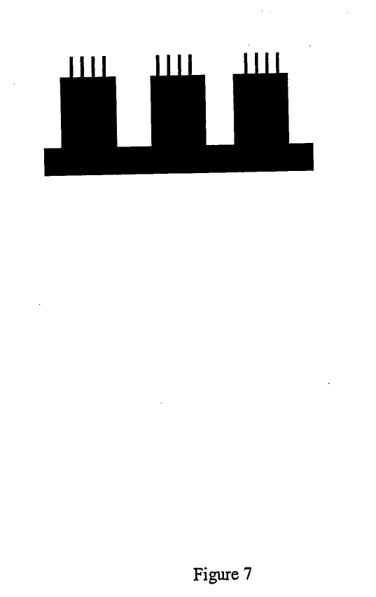

By controlling the strength of the first fluid and the length of time for which the consolidated object or portion is exposed to the first fluid, the removable portion of the dispersed domain can be etched away to a pre-selected depth below the surface of the consolidated object or portion thereof that is exposed to the first fluid. Removal of a portion of the dispersed domain, and the subsequent removal of all of the matrix polymer, will leave the group of dispersed domains that are exposed above the surface of the substrate as a first tier of fibrils, each of which is secured at a first end to the substrate. Also remaining will be the portion of each dispersed domain that was not removed by the first fluid as a second tier of fibrils, each such second tier fibril being attached to a second end of a single first tier fibril. This type of fibrillar microstructure may be seen in FIG. 7.

After the matrix has been removed, or after removal of both the matrix and one of the components of the dispersed domains, the solvent(s) used may be removed from the resulting fibrils by air drying. Alternatively, however, the solvent(s) may be removed by displacing it/them with a transfer liquid, and then displacing the transfer liquid with a drying liquid that is below its critical point. The drying liquid is then removed from the fibrils by converting it to a gas above its critical point.

Normal air drying typically creates very large surface tension forces in cavities of small dimensions when there is a liquid/gas interface. As a fibrillar microstructure dries, the liquid/gas interface travels through it, and collapses cavities between adjacent fibrils. This may cause adjacent fibrils to collapse and become clumped together. The critical point method of drying avoids these effects by never allowing a liquid/gas interface to develop, and in this way the fibrils are not exposed to surface tension forces.

The transfer liquid must be cosoluble with both the solvent(s) to be displaced and the drying liquid, which may for example be liquid CO₂. Thus, the transfer liquid, which may for example be ethanol, displaces the solvent, and the drying liquid then displaces the transfer liquid, while the sample is always kept wetted by keeping it below the liquid surface. After the transfer liquid is substantially washed out, by multiple flushes if necessary, the pressure is pushed above the critical pressure, Pc, and the temperature is pushed above the critical temperature, Tc, which carries the system above the critical point. Typically, the pressure is then slowly dropped back to atmospheric while keeping the temperature higher than Tc, and the sample is thus critical point dried. For example, if acetone, cyclohexane or a mixture thereof is used as the solvent, ethanol may be used as the transfer liquid, and CO₂ may be used as the drying liquid.

The critical point of a liquid/gas system (e.g. liquid CO₂/CO₂gas) is its critical temperature and the pressure associated with this temperature. It is then, for example, a point T_{c}, P_{c} and those points on the T,P phase diagram that are smaller. Above the critical temperature, the system is always gaseous and cannot be liquefied by the application of pressure. The transition from liquid to gas at the critical point takes place without an interface because the densities of liquid and gas are equal at this point, and the liquid is taken from below its critical temperature and transformed to gas above its critical temperature. If the fibrillar microstructure is totally immersed in a drying liquid below its critical point, and if the drying liquid is then taken to a temperature and pressure above its critical point, the fibrillar microstructure then becomes immersed in gas (i.e. is dried) without being exposed to damaging surface tension forces. In this procedure, the liquid/gas meniscus becomes diffuse and then disappears.

Liquid CO₂ is the most common drying medium, but nitrous oxide and fluorocarbons have also been used for this purpose. Critical point drying is typically carried out in a pressure vessel with an integral water jacket for heating and cooling. The normal operating range of the pressure chamber is 0-2000 psi and 10-50° C. Suitable devices may be obtained, for example, from Structure Probe, Inc., West Chester Pa., or Electron Microscopy Sciences, Hatfield Pa.

In an alternative embodiment, the solvent that has dissolved the matrix phase may be removed by lyophilization. Lyophilization, commonly referred to as freeze drying, is the process of removing a liquid from a product by sublimation and desorption. This process is performed in lyophilization equipment which consists of a drying chamber with temperature controlled shelves, a condenser to trap material removed from the product, a cooling system to supply refrigerant to the shelves and condenser, and a vacuum system to reduce the pressure in the chamber and condenser to facilitate the drying process.

Lyophilization cycles consist of three phases: freezing, primary drying, and secondary drying. During the freezing phase, the goal is to freeze the mobile liquid of the product by cooling the product to a temperature below its lowest eutectic point, which is the temperature and composition coordinate below which only the solid phase exists. This temperature may then be maintained throughout the primary drying phase. If the product has components that do not crystallize during freezing and thus does not have a eutectic point, drying should be performed at temperatures below the glass transition temperature of the amorphous phase. The glass transition temperature will be determined by the composition of the amorphous phase in the frozen product, which, in turn, is dictated by the product formulation and the freezing procedure employed. In the primary drying phase, the chamber pressure is reduced, and heat is applied to the product to cause the frozen mobile liquid to sublime. The liquid vapor is then collected on the surface of a condenser.

Critical point drying and lyophilization are useful regardless of the method by which a fibrillar microstructure is made. For example, a fibrillar microstructure may be made by a method of
providing a plurality of composite filaments, each filament comprising a plurality of elongated domains of at least a first polymer;

wherein each elongated domain is elongated along a longitudinal axis of the filament, and is dispersed within a matrix of a second polymer; and wherein a longitudinal axis of each dispersed domain is not orthogonal to the longitudinal axis of the filament;
forming a fabric from the filaments and a backing; and
removing the matrix polymer from the fabric with a liquid solvent.
   The solvent may then be removed from the fabric by displacing it with a drying liquid that is below its critical point, and then removing the drying liquid from the fabric by converting it to a gas above its critical point. Alternatively, the solvent may be removed by lyophilization.

In the method described above, the fabric may be formed by preparing a web or porous mat of the filaments, impregnating the web or mat with an oligomeric or polymeric material, and hardening or setting the impregnated material to form the backing. In an alternative embodiment, however, the fabric may be prepared by the method set forth above for preparing a fibrillar microstructure, and the fabric may have the characteristics of a fibrillar microstructure.

A fibrillar microstructure, prepared by a method as set forth above, will typically contain a substrate, and a plurality of fibrils, each of which is attached at an end to the substrate. A fibril suitable for this purpose will typically have

a length L in the range of about 1 to about 150 microns, but alternatively in the range of about 10 to about 150 microns;

a characteristic width a in the range of about 0.1 to about 10 microns, but alternatively in the range of about 0.1 to about 3 microns, or about 0.1 to about 0.5 microns;

a ratio of L/a in the range of about 5 to about 30; and

a Young's modulus (as determined by ASTM D412-87) in the range of about 0.1 to about 10 GPa.

In an alternative embodiment, a fibrillar microstructure containing two tiers of fibrils, prepared by a method as set forth above, will typically contain (a) a substrate, (b) a plurality of first-tier fibrils, each of which is attached at a first end to the substrate, and (c) a plurality of second tier fibrils, each of which is attached to a second end of a first-tier fibril.

A first-tier fibril will typically have a length L¹ in the range of about 10 to about 150 microns, a characteristic width a¹ in the range of about 2 to about 10 microns, a ratio of L¹/a¹ in the range of about 5 to about 15, and a Young's modulus (as determined by ASTM D412-87) in the range of about 0.1 to about 10 GPa. The ratio of the portion of the area of the substrate on which first-tier fibrils are attached to the total area of the substrate is typically in the range of about 0.03 to about 0.3.

A second-tier fibril will typically have a length L² in the range of about 0.5 to about 15 microns, a characteristic width a² in the range of about 0.1 to about 1 microns, a ratio of L²/a² in the range of about 5 to about 15, and a Young's modulus (as determined by ASTM D412-87) in the range of about 0.1 to about 10 GPa. The ratio of the portion of the area of the second end of a first-tier fibril on which second-tier fibrils are attached to the total area of the second end of the first-tier fibril is typically in the range of about 0.03 to about 0.15.

The ratio of (L¹+L²)/a² is typically in the range of about 100 to about 175.

The characteristic width of a fibril is the length of the longest dimension of the largest cross-sectional shape of the fibril, such as the diameter of a circle.

Spacing controls the areal density of the fibrils (or the first-tier fibrils when a second tier exists) on the substrate, and the areal density of the second-tier fibrils (when they exist) on each first-tier fibril. Areal density is defined as the percentage of the area of a surface, either the substrate or the top of a first-tier fibril, occupied by the point of junction between fibril and surface of the fibrils that are secured thereto. The areal density of fibrils on the substrate, or the areal density on the substrate of the first-tier fibrils when two tiers exist, may be in the range of about 3 to about 30 percent (or alternatively in the range of about 5 to about 10 percent). When they exist, the areal density of second tier fibrils on a first-tier fibril may be in the range of about 3 to about 15 percent (or alternatively in the range of about 5 to about 10 percent).

In various embodiments, one or more of the fibrils may have a neutral axis, passing through the centroid of the cross-sectional area of the fibril, that has an orientation with the plane of the substrate, at the point of intersection of the axis with the plane of the substrate, in the range of greater than 75° to about 90°. Such orientation of the neutral axis may moreover be in the range of about 80° to about 90°, or even in the range of about 85° to about 90°. Methods for determination of the orientation of a neutral axis are known in the art from sources such as An Introduction to the Mechanics of Solids, R. R. Archer et al, McGraw-Hill (1978), the teachings of which concerning a neutral axis are incorporated as a part hereof for all purposes.

The fibrils in a fibrillar microstructure according to this invention may further have other properties as set forth in US 2004/076,822 (WO 03/102,099), which is incorporated in its entirety as a part hereof for all purposes.

In this invention, the polymers from which the dispersed domains and/or the matrix may be made include polymers and copolymers, and blends of two or more of either or both that are amenable to extrusion and spinning. Exemplary polymers and/or copolymers include polyacetal, polyacetylene, polyacrylamide, polyacrylate, polyacrylic acid, polyacrylonitrile, polyamide, polyaminotriazole, polyaramid, polyarylate, polybenzimidazole, polybutadiene, polybutylene, polycarbonate, polychloroprene, polyesters, polyethers, polyethylenes (including halogenated polyethylenes), polyethylene imine, polyethylene oxide, polyimide, polyisoprene, polymethacrylate, polyoxadiazole, polyphenylene oxide, polyphenylene sulfide, polyphenylene triazole, polypropylene, polypropylene oxide, polysiloxanes (including polydimethyl siloxane), polystyrene, polysulfone, polyurethane, poly(vinyl acetal), poly(vinyl acetate), poly(vinyl alcohol), poly(vinyl butyral), poly(vinyl carbazole), poly(vinyl chloride), poly(vinyl ether), poly(vinyl fluoride), acrylonitrile/butadiene/styrene copolymer, acrylate copolymers (including ethylene/vinyl acetate/glycidyl methacrylate copolymer), styrene/acrylonitrile copolymer.

The polymers and/or copolymers from which a dispersed and/or matrix phase is made may be selected from one or more subgroups of the foregoing formed by omitting any one or more members from the whole group as set forth in the list above. As a result, the polymer and/or copolymer may in such instance not only be one or more members selected from any subgroup of any size that may be formed from the whole group as set forth in the list above, but may also be selected in the absence of the members that have been omitted from the whole group to form the subgroup. The subgroup formed by omitting various members from the whole group in the list above may, moreover, be an individual member of the whole group such that the polymer or copolymer is selected in the absence of all other members of the whole group except the selected individual member. The subgroup formed by omitting various members from the whole group in the list above may, moreover, contain any number of the members of the whole group such that those members of the whole group that are excluded to form the subgroup are absent from the subgroup.

As noted above, the dispersed domains may be made from a mixture of two or more than two polymers and/or copolymers. In such event, each polymer in the mixture may be present in an amount in the range of about 20 to about 80 percent of the total weight of the mixture.

Examples of polymers particularly suitable for use as a dispersed domain include polyamide, poly(ether/amide), polyester, poly(ether/ester), polypropylene, polyacrylate and polycarbonate. Examples of polymers particularly suitable for use as the matrix include polystyrene, polyamide, polyethylene, and a blend of polyvinyl alcohol and polyethylene glycol. The blend of polyvinyl alcohol and polyethylene glycol may have particular advantages as it may be solubilized with an aqueous solvent. Examples of polymers particularly suitable for use as the substrate include polypropylene, polyester, polyacrylate (such as a partially neutralized ethylene/acrylate copolymer) and polyvinylidine chloride.

The advantageous effects of this invention are demonstrated by a series of examples, as described below. The embodiments of the invention on which the examples are based are illustrative only, and do not limit the scope of the invention.

### EXAMPLE 1

A nylon microfiber is attached to a commercial Saran® brand polyvinylidene chloride film of nominal 0.0787 cm thickness, forming a fibrillar microstructure having 30% areal density.

A yarn is spun by extruding polystyrene and nylon-66 at about 295° C. through a 198 hole, 600 subhole islands-in-the-sea spinneret obtained from Hills, Inc, West Melbourne, Fla. The resulting yarn is quenched at about 25° C. in cross-flow air. Subsequently, it is wound onto a feed roll at about 200 m/min at ambient conditions, over a tension roll running at about 202 m/min and ambient temperature, then over draw roll #1 at 205 m/min and 115° C., then over draw roll #2 at 300 m/min and 120° C., then over a relaxer roll at 290 m/min and ambient temperature, and finally onto a windup.

The resulting yarn contained 198 filaments of about 70 wt % Polystyrene/30 wt % Nylon-66, with each filament containing 600 islands, or sub-filaments, of nylon. A total of 198×600 or 118,800 sub-filaments per yarn are obtained. Each subfilament is approximately of 0.8 micron in diameter.

This yarn is drawn off-line 2.72×original length (for a total mechanical draw ratio of 2.72×1.45, or 3.94×original length), over an ambient temperature annealing roll, and wound up. The yarn is laid up in a press mold which is preheated to 130° C. over two hours, and pressed in a carver press at about 13.8 MPa to form a uni-axial composite bar measuring approximately 3.1750×0.6350×0.3175 cm. The mold is cooled in ice water and the bar is removed.

This bar is trimmed with a jeweler's saw to expose the center, then microtomed at right angles to the fiber axis, forming a transverse slab approximately 2 mm×2 mm×5 microns. This slab is placed on a 9 micron film of SARAN® polyvinylidene chloride household wrap, previously adhered to a glass microscope slide, and hot rolled at 210° C. so as to stick the slab to the surface of the backing film.

The slide bearing this slab/film structure is soaked overnight in a solution of 50/50 volume/volume percent of acetone and cyclohexane, which dissolves the polystyrene, leaving a carpet or velvet-like structure of nylon fibers on a polyvinylidene chloride backing. The fibrillar microstructure is then rinsed with acetone and placed in a dessicator to dry. FIG. 4 shows a micrograph of the embodiment.

### EXAMPLE 2

A fibrillar microstructure having 10% areal density is made of polyethylene terephthalate (PET) microfiber attached to a film of nominal 0.1574 cm thickness prepared from Surlyn® brand ionomer from DuPont.

A yarn is spun by extruding a 90/10 weight/weight percent flake blend of polystyrene (PS), which is pre-vacuum dried for 72 hours at 80° C., and Crystar® brand polybutylene terephthalate polyester from DuPont, which is pre-vacuum dried at 130° C. for 16 hours. The yarn is made by using a 34 hole spinneret with a Length/Diameter of 40/10 mils. The spinneret is held at 295° C. during the extrusion and yarn spinning process. The yarn is quenched at room temperature in cross-flow air, drawn 1.6× original length from a feed roll at 500 m/min at 60° C., then over draw rolls at 800 m/min and ambient temperature, then let down to a relaxer roll at 785 m/min and ambient temperature, and wound up. The yarn is thus composed of a large number of discontinuous, approximately 0.1 micron elongated domains of PET contained within a continuous PS matrix. The 34 filament yarn is about 151 denier.

The yarn is cut into about 3.2 cm segments, which are laid up in a press mold. The press mold is preheated to about 130° C. for more than two hours, and the yarn is pressed in a Carver press at 13.8 MPa to form a uni-axial composite bar measuring approximately 3.1750×0.6350×0.3175 cm. The mold is cooled in ice water and the bar removed. This bar is trimmed with a jeweler's saw to expose the center, then microtomed at right angles to the fiber axis, forming a transverse slab approximately 1 mm×1 mm×1 micron. This slab is placed on a 50 micron film prepared from SURLYN® brand ionomer from DuPont, previously adhered to a glass microscope slide, and hot rolled at 120° C. so as to stick the slab to the surface of the backing film.

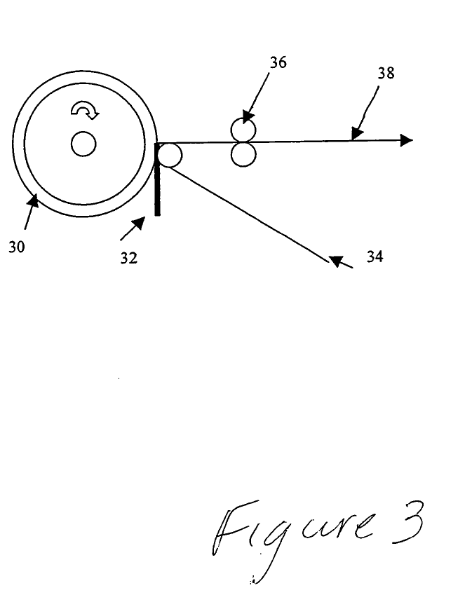

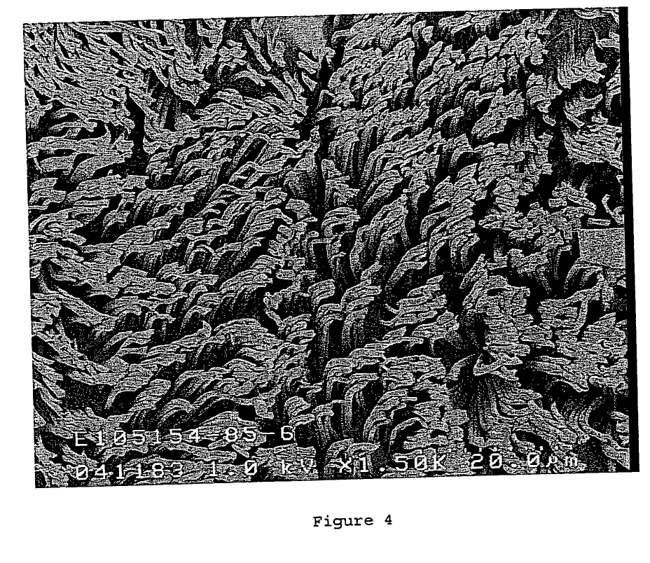

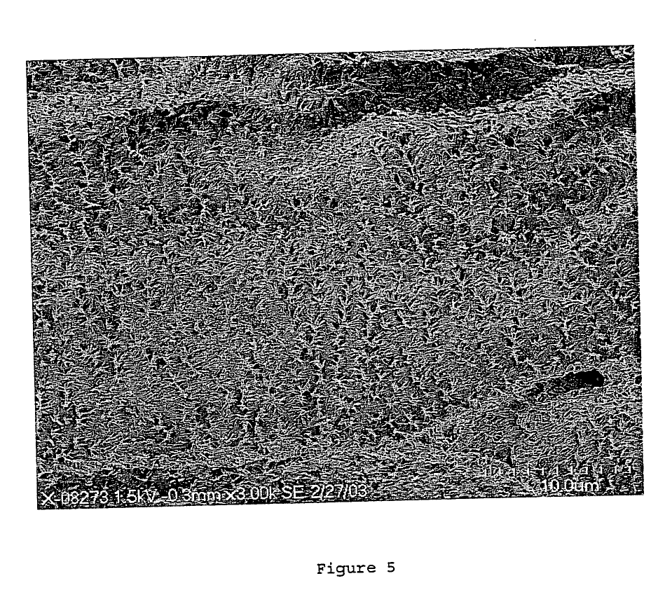

The slide bearing this slab/film structure is soaked overnight in a solution of 50/50 volume/volume percent of acetone and cyclohexane, which dissolves the polystyrene, leaving a carpet or velvet-like structure of PET fibers on an ionomer backing. The fibrillar microstructure is then rinsed with acetone and air dried. FIG. 5 shows a micrograph of the sample product.

### EXAMPLE 3

A fibrillar microstructure having 10% areal density is prepared from polypropylene microfiber attached to a film of nominal 0.1574 cm thickness prepared from Surlyn® brand ionomer from DuPont.

A yarn is spun by extruding polystyrene and polypropylene at about 295° C. through a 198 hole, 64 subhole islands-in-the-sea spinneret from Hills, Inc. The yarn is quenched at about 25° C. in crossflow air, wound onto a feed roll at 200 m/min at ambient temperature, then over a tension roll running at 202 m/min and ambient temperature, then over draw roll #1 at 205 m/min and 115° C., then over draw roll #2 at 300 m/min and 120° C., then over a relaxer roll at 290 m/min and ambient temperature, and onto a windup. This yarn now contained 198 filaments of 90 wt % polystyrene/10 wt % polypropylene, with each filament containing 64 islands (or sub-filaments) of polypropylene, for a total of 198×64 or 12,672 sub-filaments per yarn. The yarn is about 1806 denier with each sub-filament approximately 1.3 micron in diameter.

This yarn is cut into about 3.2 cm segments, which are laid up in a press mold that is preheated to 130° C. for more than two hours, and are pressed in a Carver press at about 13.8 MPa to form a uni-axial composite bar measuring approximately 3.1750 cm×0.6350 cm×0.3175 cm. The mold is cooled in ice water and the bar is removed.

This bar is trimmed with a jeweler's saw to expose the center, then microtomed at right angles to the fiber axis, forming a transverse slab approximately 1 mm×1 mm×6.5 microns. This slab is placed on a 50-micron film prepared from SURLYN® brand ionomer from DuPont that is previously adhered to a glass microscope slide, and hot rolled at 140° C. so as to stick the slab to the surface of the backing film.

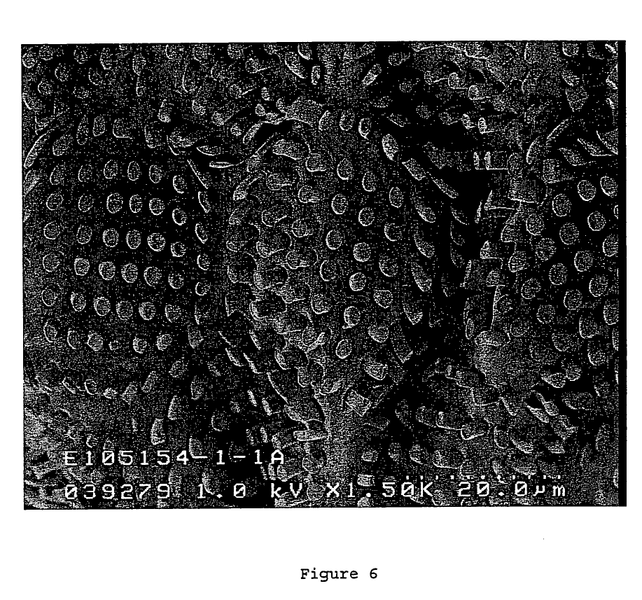

The slide bearing this slab/film structure is soaked overnight in a solution of 50/50 volume/volume percent of acetone and cyclohexane, which dissolves the polystyrene, leaving a carpet or velvet like structure of polypropylene fibers on an ionomer backing. This fibrillar microstructure is then rinsed with acetone and air dried. FIG. 6 shows a micrograph of the sample product.

### EXAMPLE 4

A fibrillar microstructure is prepared from polyethylene terephthalate (“PET”) microfiber attached to a film of nominal 0.1574 cm thickness prepared from Surlyn® brand ionomer from DuPont.

A yarn is spun by extruding polystyrene and a blend of 10 wt % PET in nylon 66 at about 295° C. through a 198 hole, 64 subhole islands-in-the-sea spinneret from Hills, Inc. The yarn is quenched at about 25° C. in crossflow air, wound onto a feed roll at 160 m/min at ambient temperature, then over a tension roll running at 162 m/min and ambient temperature, then over draw roll #1 at 184 m/min and 115° C., then over draw roll #2 at 300 m/min and 120° C., then over a relaxer roll at 288 m/min and ambient temperature, and onto a windup.

This yarn now contains 198 filaments of 70 vol % polystyrene/30 vol % of the 10 wt % blend of PET in nylon-66, with each filament containing 64 islands (or sub-filaments) of nylon blend, for a total of 198×64 or 12,672 sub-filaments per yarn. The yarn is about 1800 denier with each sub-filament approximately 1.3 micron in diameter. This yarn is drawn 2.38× over an ambient draw roll and annealed, without letdown, at 160° C. over an anneal roll running at 14.3 m/min.

This yarn is then cut into about 3.2 cm segments, which are laid up in a press mold that is preheated to 130° C. for more than two hours, and are pressed in a Carver press at about 13.8 MPa to form a uni-axial composite bar measuring approximately 3.1750 cm×0.6350 cm×0.3175 cm. The mold is cooled in ice water and the bar is removed.

This bar is trimmed with a jeweler's saw to expose the center, then microtomed at right angles to the fiber axis, forming a transverse slab approximately 1 mm×1 mm×6.5 microns. This slab is placed on a 20-micron film prepared from type 8320 SURLYN® brand ionomer from DuPont that is previously adhered to a glass microscope slide, and hot rolled at 140° C. so as to stick the slab to the surface of the backing film.

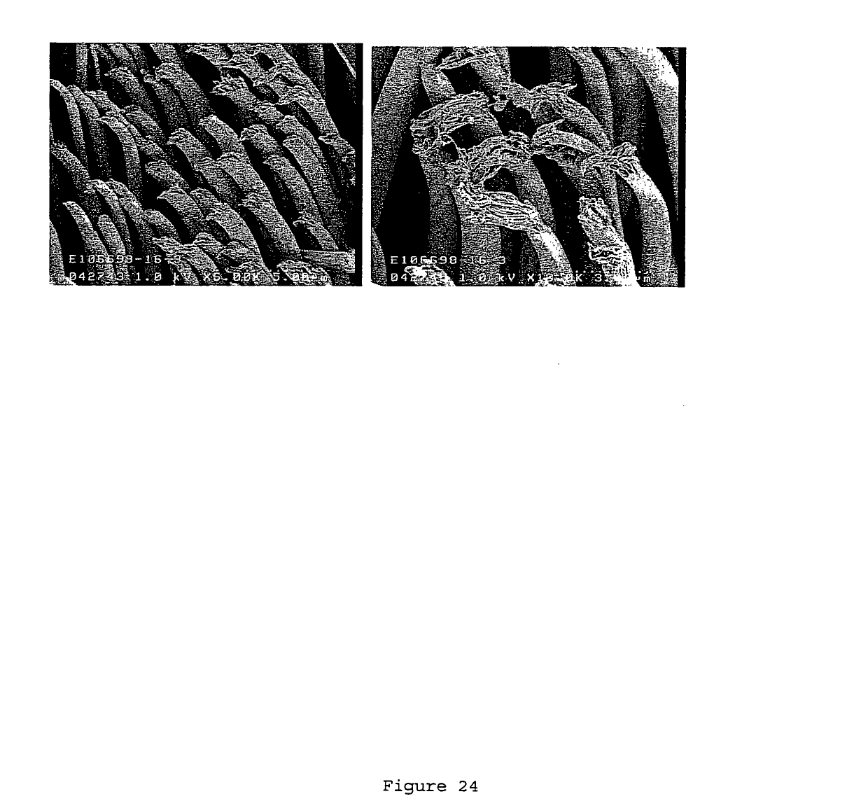

The bonded slab is then etched with 70% aqueous formic acid for 20 seconds to partially dissolve nylon present in the islands, rinsed with 50% formic acid, and then acetone before being placed in a 50/50 acetone/cyclohexane polystyrene solvent. The slide bearing this slab/film structure is soaked overnight in a solution of 50/50 volume/volume percent of acetone and cyclohexane, which dissolves the polystyrene, leaving a two-tiered carpet or velvet like structure of PET fibers on an ionomer backing with nylon fibrils on each PET fibril. This fibrillar microstructure is then rinsed with acetone and critical point dried. FIG. 24 shows an example of the final product.

The fibrillar microstructure of this invention, and the fibrillar microstructures made by the methods of this invention, are useful to make fabrics, to make objects that have adhesive surfaces, and to make coverings for solid objects such a wall paper.

Where an apparatus or method of this invention is stated or described as comprising, including, containing, having, being composed of or being constituted of or by certain components or steps, it is to be understood, unless the statement or description explicitly provides to the contrary, that one or more components or steps other than those explicitly stated or described may be present in the apparatus or method. In an alternative embodiment, however, the apparatus or method of this invention may be stated or described as consisting essentially of certain components or steps, in which embodiment components or steps that would materially alter the principle of operation or the distinguishing characteristics of the apparatus or method would not be present therein. In a further alternative embodiment, the apparatus or method of this invention may be stated or described as consisting of certain components or steps, in which embodiment components or steps other than those as stated would not be present therein.

Where the indefinite article “a” or “an” is used with respect to a statement or description of the presence of a component in an apparatus, or a step in a method, of this invention, it is to be understood, unless the statement or description explicitly provides to the contrary, that the use of such indefinite article does not limit the presence of the component in the apparatus, or of the step in the method, to one in number.

What is claimed is:

1. A method for making a fibrillar microstructure comprising
(a) providing a plurality of composite filaments, each filament comprising a plurality of elongated domains of at least a first polymer; wherein each elongated domain is elongated along a longitudinal axis of the filament, and is dispersed within a matrix of a second polymer; and wherein a longitudinal axis of each dispersed domain is not orthogonal to the longitudinal axis of the filament;
(b) forming a fabric from the filaments and a backing;
(c) removing the matrix polymer from the fabric with a liquid solvent;
(d) removing the solvent from the fabric by displacing it with a drying liquid that is below its critical point; and
(e) removing the drying liquid from the fabric by converting it to a gas above its critical point.

2. A method for making a fibrillar microstructure comprising
(a) providing a plurality of composite filaments, each filament comprising a plurality of elongated domains of at least a first polymer; wherein each elongated domain is elongated along a longitudinal axis of the filament, and is dispersed within a matrix of a second polymer; and wherein a longitudinal axis of each dispersed domain is not orthogonal to the longitudinal axis of the filament;
(b) forming a fabric from the filaments and a backing;
(c) removing the matrix polymer from the fabric with a liquid solvent;
(d) removing the solvent from the fabric by lyophilization.

3. A method according to claims 1 or 2 wherein the fabric is formed by preparing a web or porous mat of the filaments, impregnating the web or mat with an oligomeric or polymeric material, and hardening or setting the impregnated material to form the backing.

4. A method according to claims 1 or 2 wherein the fabric is formed by
(b-1) consolidating the plurality of composite filaments into an object having at least one surface in which the longitudinal axis of each dispersed domain is essentially orthogonal to the plane of the surface;
(b-2) removing a portion of the object that includes the surface; and
(b-3) securing the portion of the object removed in (b-2) to a substrate.

5. A method according to claims 1 or 2 wherein the fabric is formed by
(b-1) consolidating the plurality of composite filaments into an object having at least one surface in which the longitudinal axis of each dispersed domain is essentially orthogonal to the plane of the surface;
(b-2) securing a substrate to the surface; and
(b-3) removing a potion of the object that includes the surface that is secured to the substrate.

6. A method according to claim 4 wherein a composite filament is provided by processing the first and second polymers through an islands-in-the-sea spinneret.

7. A method according to claim 4 wherein a composite filament is provided by mixing the first and second polymers and processing the mixture through a tubular spinneret capillary.

8. A method according to claim 4 wherein the first polymer is selected from the group consisting of polyacetal, polyamide, poly(ether/amide), polyester, poly(ether/ester), polyethylene, polypropylene, polyacrylate, polycarbonate, polyvinyl chloride poly(vinyl acetate), and acrylonitrile/butadiene/styrene copolymer.

9. A method according to claim 4 wherein the second polymer is selected from the group consisting of polypropylene and polystyrene.

10. A method according to claim 4 comprising a step of providing a substrate prepared form an acrylate polymer.

11. A method according to claim 4 wherein a dispersed domain comprises at least one third polymer that is different from the first polymer.

12. A method according to claim 11 wherein each dispersed domain comprising a third polymer is separate from each dispersed domain that comprises a first polymer.

13. A method according to claim 11 wherein a dispersed domain comprises the first and third polymers mixed together.

14. A method according to claim 11 further comprising a step of removing from a dispersed domain, before removing the matrix polymer, a portion of the first polymer, a portion of the third polymer, or a portion of the first and third polymers.

15. A method according to claim 4 wherein the second polymer is soluble with an aqueous solvent.
